(19) United States
(12) Patent Application Publication
(10) Pub. No.: US 2026/0105419 A1
(43) Pub. Date: Apr. 16, 2026

(54) METHOD AND SYSTEM FOR FACILITATING/ARRANGING MEETINGS

(71) Applicant: Pericles John LANTZ, Clearwater, FL (US)

(72) Inventor: Pericles John LANTZ, Clearwater, FL (US)

(21) Appl. No.: 19/113,824

(22) PCT Filed: Sep. 29, 2023
(86) PCT No.: PCT/IB2023/059751

§ 371 Date: Mar. 20, 2025

Related U.S. Application Data
(60) Provisional application No. 63/411,858, filed on Sep. 30, 2022.

(51) Int. Cl. G06Q 10/1093; H04W 4/021

(52) U.S. Cl. CPC G06Q 10/1093; H04W 4/021

(57) ABSTRACT

A system for, and method of, facilitating a meeting. The system includes a scheduling module which is configured to determine a possible meeting place for two or more people to meet and communicate the meeting place to both people via a communication network. The scheduling module is further configured to determine whether the two people are at the meeting place, and if so, generate a coupon/discount/incentive benefit which can be redeemed by one or both people at the meeting place. The scheduling module may more specifically be configured to determine a possible meeting place based on (i) a present geographical location of each user or (ii) a possible future geographical location of each user at a particular point in time.

### CROSS REFERENCE TO RELATED APPLICATIONS

This patent application claims priority under 35 U.S.C. § 371 to Patent Cooperation Treaty (PCT) Application No. PCT/IB2023/059751, filed Sep. 29, 2023, which claims benefit of priority under 35 U.S.C. § 119(e) from U.S. Provisional Application No. 63/411,858, filed Sep. 30, 2022, both of which are hereby incorporated by reference in their entirety.

### BACKGROUND OF THE INVENTION

THIS invention relates to a system and method for arranging meetings.

Currently, when someone wants to arrange a meeting, they would typically correspond with a person via email in order to determine a possible date, time and place which would be suitable for both people. This can be a time-consuming process, especially when trying to meet with various people in a short period of time.

The inventor wishes to address this problem.

### SUMMARY OF THE INVENTION

In accordance with a first aspect of the invention there is provided a method of arranging a meeting, wherein the method includes:
determining/identifying, by using a processor, a time period (hereinafter referred to as the “period of availability”) during which a particular person may be available for a meeting(s) and a location/geographic area of where the particular person may be during the particular period of availability;
identifying, by using a processor, a person (hereinafter referred to as the “connected person”) which is connected with the particular person through one or more social media platforms or whose contact information was/has been provided by, or obtained from, the particular person, and who may also be available for a meeting during the period of availability and who may be at/within/near/proximate the same location/geographic area as the particular person during the period of availability;
identifying, by using a processor, a possible meeting place/location, based on the location/geographic area of where the particular person may be during the particular period of availability; and
scheduling, by using a processor, a meeting between the particular person and the identified connected person.

The step of determining/identifying the period of availability may include:
receiving/retrieving, by using a processor, schedule information of the particular user, wherein the schedule information includes
   availability information on when the particular person may be available for a meeting(s) (hereinafter referred to as “periods of availability”), and
   location information which relates to a location at which, or area within which, the particular person may be during each period of availability.

The step of identifying a connected person may more specifically include comparing, by using a processor, the schedule information of the particular person with schedule information of people who are connected with the particular person through one or more social media platforms or whose contact information was/has been provided by, or obtained from, the particular person (hereinafter referred to as “connected people”), in order to identify one or more connected people which the particular person could meet with during a particular period of availability.

The step of scheduling the meeting may include scheduling the meeting at the identified meeting place/location and communicating, via a communication network, details of the scheduled meeting to the particular user and the identified connected person. The details of the scheduled meeting may be sent to a mobile communication device (e.g. a smart device, such as a smart phone) of the particular user and a mobile communication device (e.g. a smart device, such as a smart phone) of the identified connected person.

The method may include receiving a request, via a communication network, from the particular person to schedule a meeting with the identified connected person. The method may further include sending a meeting request to the identified connected person via a communication network and receiving a response from the identified connected person. The meeting request may be sent to the mobile communication device of the connected person.

The response may be received from the mobile communication device of the connected person.

The step of scheduling the meeting may include only scheduling the meeting if the response indicates that the identified connected person approves the meeting request.

In accordance with a second aspect of the invention there is provided a system for arranging meetings, wherein the system includes:
an identification module which is configured to
determine/identify a time period (hereinafter referred to as the “period of availability”) during which a particular person may be available for a meeting(s) and a location/geographic area of where the particular person may be during the particular period of availability,
identify a person (hereinafter referred to as the “connected person”) which is connected with the particular person through one or more social media platforms or whose contact information was/has been provided by, or obtained from, the particular person, and who may also be available for a meeting during the period of availability and who may be at/within/near/proximate the same location/geographic area as the particular person during the period of availability, and
identify a possible meeting place/location, based on the location/geographic area of where the particular person may be during the particular period of availability; and
a scheduling module which is configured to schedule a meeting between the particular person and the identified connected person.

A “module”, in the context of the specification, includes an identifiable portion of code, computational or executable instructions, or a computational object to achieve a particular function, operation, processing, or procedure. A module may be implemented in software, hardware or a combination of software and hardware. Furthermore, modules need not necessarily be consolidated into one device.

The identification module may be configured to determine/identify the period of availability by receiving/retrieving schedule information of the particular user wherein the schedule information includes:
availability information on when the particular person may be available for a meeting(s) (hereinafter referred to as “periods of availability”), and
location information which relates to a location at which the particular person may be during each period of availability.

The schedule information may be retrieved/received from a mobile communication device (e.g. a smart device, such as a smart phone) of the particular user via a communication network.

The schedule information may be retrieved/obtained from a digital calendar of the particular person.

The identification module may be configured to identify a connected person by comparing the schedule information of the particular person with schedule information of people who are connected with the particular person through one or more social media platforms or whose contact information was/has been provided by, or obtained from, the particular person (hereinafter referred to as “connected people”), in order to identify one or more connected people which the particular person could meet with during a particular period of availability.

The scheduling module may be configured to schedule the meeting at the identified meeting place/location and communicate, via a communication network, details of the scheduled meeting to the particular user and the identified connected person (e.g. to their respective mobile communication devices (e.g. their smart devices, such as smart phone).

The scheduling module may be configured to update the digital calendar of the particular person with the scheduled meeting. The scheduling module may be configured to update a digital calendar of the identified connected person.

The scheduling module may be configured to receive a request, via a communication network, from the particular person to schedule a meeting with the identified connected person. The scheduling module may be further configured to send a meeting request to the identified connected person (e.g. to his/her mobile communication device) via a communication network and receive a response from the identified connected person (e.g. from his/her mobile communication device). The scheduling module may be configured to schedule the meeting only if the response indicates that the identified connected person approves the meeting request.

In accordance with a third aspect of the invention there is provided a mobile application which includes:
an identification module which is configured to
   determine/identify a time period (hereinafter referred to as the “period of availability”) during which a particular person, on whose mobile communication device (e.g. a smart device, such as smart phone) the mobile application is installed, may be available for a meeting(s) and a location/geographic area of where the particular person may be during the particular period of availability,
   identify a person (hereinafter referred to as the “connected person”) which is connected with the particular person through one or more social media platforms or whose contact information was/has been obtained/imported from a contact list on the mobile communication device, and who may also be available for a meeting during the period of availability and who may be at/within/near/proximate the same location/geographic area as the particular person during the period of availability, and
   identify a possible meeting place/location, based on the location/geographic area of where the particular person may be during the particular period of availability; and
   a scheduling module which is configured to schedule a meeting between the particular person and the identified connected person.

The mobile communication device may be a smart device, more specifically a smart phone or tablet.

The identification module may be configured to determine/identify the period of availability by obtaining/retrieving schedule information of the particular user wherein the schedule information includes:
availability information on when the particular person may be available for a meeting(s) (hereinafter referred to as “periods of availability”), and
location information which relates to a location at which the particular person may be during each period of availability.

The schedule information may be retrieved/obtained from a digital calendar of the particular person. The digital calendar may be accessible on the mobile communication device. The digital calendar may be installed on the mobile communication device.

The identification module may be configured to identify a connected person by comparing the schedule information of the particular person with schedule information of people who are connected with the particular person through one or more social media platforms or whose contact information was/has been provided by, or obtained from, the particular person (hereinafter referred to as “connected people”), in order to identify one or more connected people which the particular person could meet with during a particular period of availability.

The schedule information of each person of the connected people may be obtained/retrieved, via a communication network, from a digital calendar of the person.

The scheduling module may be configured to schedule the meeting at the identified meeting place/location and communicate, via a communication network, details of the scheduled meeting to the identified connected person (e.g. to the identified connected person's mobile communication device (e.g. smart device, such as smart phone)). The scheduling module may be configured to update the digital calendar of the particular person with the scheduled meeting.

More specifically, the scheduling module may be configured to schedule the meeting at the identified meeting place/location by:
updating the digital calendar of the particular person with the scheduled meeting; and
communicating, via a communication network, details of the scheduled meeting to a mobile communication device of the identified connected person.

The scheduling module may be configured to receive a request, via a user interface, from the particular person to schedule a meeting with the identified connected person. The scheduling module may be further configured to send a meeting request to the identified connected person (e.g. to his/her mobile communication device) via a communication network and receive a response from the identified connected person (e.g. from his/her mobile communication device). The scheduling module may be configured to schedule the meeting only if the response indicates that the identified connected person approves the meeting request.

All of the features described in respect of the system in accordance with the second aspect of the invention also apply to the mobile application described in accordance with the third aspect of the invention.

In accordance with a fourth aspect of the invention there is provided a method of managing a loyalty program, wherein the method includes:
determining, by using a processor, when a certain predetermined number/amount of purchases have been made by a particular person at a plurality of different independent stores/business/companies which form part of a network of different independent stores/business/companies, whereby details of the network are stored on a database;
if the predetermined number/amount of purchases have been made, issuing/generating, by using a processor, a coupon/discount/incentive benefit for the particular person, which can be redeemed at a store/business/company which forms part of the network.

In accordance with a fifth aspect of the invention there is provided a system for managing a loyalty program, wherein the system includes:
a loyalty module which is configured to determine when a certain predetermined number/amount of purchases have been made by a particular person at a plurality of different independent stores/business/companies which form part of a network of different independent stores/business/companies, whereby details of the network are stored on a database;
a benefit-generating module which is configured, if the predetermined number/amount of purchases have been made, to issue/generate a coupon/discount/incentive benefit for the particular person, which can be redeemed at a store/business/company which forms part of the network.

In accordance with a sixth aspect of the invention there is provided a method of facilitating/arranging/scheduling/managing a meeting, wherein the method includes:
determining/suggesting, by using a processor, a possible meeting place for two or more people to meet and communicating the meeting place to both people via a communication network; and
determining, by using a processor, whether the two people are at the meeting place, and if so, generating a coupon/discount/incentive benefit which can be redeemed by one or both people at the meeting place.

The determining/suggesting step may more specifically include determining/suggesting a possible meeting place based on (i) a present geographical location of each user or (ii) a possible future geographical location of each user at a particular point in time. The method may include receiving, via a communication network (e.g. a mobile telecommunication network), information on (i) the present geographical location of each user or (ii) the possible future geographical location of each user at a particular point in time. For each user, the information on (i) the present geographical location of the said user or (ii) the possible future geographical location of the said user, may be received from a mobile telecommunication device, more specifically a smart device, of the said user.

The step of determining whether the two people are at the meeting place may more specifically include using geographic location information which is associated with a mobile communication device (e.g. a smart device, such as smart phone) of each person, in order to determine if the two people are at the meeting place at the same time (i.e. thereby confirming the meeting).

The method may include communicating details of the coupon/discount/incentive benefit via a communication network to the mobile communication device of one, or each of, the users.

In accordance with a seventh aspect of the invention there is provided a system for facilitating/arranging/scheduling/managing a meeting, wherein the system includes a scheduling module which is configured to:
determine/suggest a possible meeting place for two or more people to meet and communicate the meeting place to both people via a communication network; and
determine whether the two people are at the meeting place, and if so, generate a coupon/discount/incentive benefit which can be redeemed by one or both people at the meeting place.

The scheduling module may more specifically be configured to determine/suggest a possible meeting place based on (i) a present geographical location of each user or (ii) a possible future geographical location of each user at a particular point in time. The scheduling module may be configured to, via a communication network (e.g. a mobile telecommunication network), receive information on (i) the present geographical location of each user or (ii) the possible future geographical location of each user at a particular point in time. For each user, the information on (i) the present geographical location of the said user or (ii) the possible future geographical location of the said user, may be received from a mobile telecommunication device, more specifically a smart device, of the said user.

The scheduling module may more specifically be configured to use geographic location information which is associated with a mobile communication device (e.g. a smart device, such as smart phone) of each person, in order to determine if the two people are at the meeting place at the same time (i.e. thereby confirming the meeting).

The system, more specifically the scheduling module, may be configured to communicate details of the coupon/discount/incentive benefit via a communication network to the mobile communication device of one, or each of, the users.

In accordance with an eighth aspect of the invention there is provided a method of obtaining an indication of an effectiveness of an advertising campaign or a method of managing an advertising campaign, wherein the method includes:
identifying, by using a processor, a group of people to advertise an event to;
sending an advertisement/invitation related to the event to the identified group of people via a communication network; and
obtaining an indication as to how many people from the group attended the event by:
   (i) using geographic location information of mobile communication devices (e.g. smart devices, such as smart phones) which are each associated with a particular person from the group, wherein the geographic location information relates to the location of the mobile communication devices at the time/time period when/during which the event occurred/occurs, and/or
   (ii) monitoring the number of check-in indications/notifications received for the event from at least some of the people of the identified group via a communication network.

The step of identifying the group of people may include identifying the group of people based on pre-selected criteria, such as age, interests, etc.

In accordance with a ninth aspect of the invention there is provided a system for obtaining an indication of an effectiveness of an advertising campaign or a system for managing an advertising campaign, wherein the system includes a management module which is configured to:
identify a group of people to advertise an event to;
send an advertisement/invitation related to the event to the identified group of people via a communication network; and
obtain an indication as to how many people from the group attended the event by:
   (i) using geographic location information of mobile communication devices (e.g. smart devices, such as smart phones) which are each associated with a particular person from the group, wherein the geographic location information relates to the location of the mobile communication devices at the time/time period when/during which the event occurred/occurs; and/or
   (ii) monitoring the number of check-in indications/notifications received for the event from at least some of the people of the identified group via a communication network.

The management module may be configured to identify the group of people based on pre-selected criteria, such as age, interests, etc.

In accordance with a tenth aspect of the invention there is provided a method of facilitating/arranging/scheduling/managing a meeting, wherein the method includes:
determining/suggesting, by using a processor, a possible meeting place for two or more people to meet and communicating the meeting place to both people via a communication network;
determining, by using a processor, whether the two people are at the meeting place; and
receiving a payment amount into an account, wherein the payment amount is received as a result of a purchase(s) made by one or both people at the meeting place.

The payment amount may be received from an account with is associated with the particular meeting place (e.g. a coffee shop).

The payment amount may relate to a royalty fee/referral fee which is received from an entity which is associated with the meeting place (e.g. the entity owning/running the meeting place, such as a coffee shop).

The determining/suggesting step may more specifically include determining/suggesting a possible meeting place based on (i) a present geographical location of each user or (ii) a possible future geographical location of each user at a particular point in time. The method may include receiving, via a communication network (e.g. a mobile telecommunication network), information on (i) the present geographical location of each user or (ii) the possible future geographical location of each user at a particular point in time. For each user, the information on (i) the present geographical location of the said user or (ii) the possible future geographical location of the said user, may be received from a mobile telecommunication device, more specifically a smart device, of the said user.

The step of determining whether the two people are at the meeting place may more specifically include using geographic location information which is associated with a mobile communication device (e.g. a smart device, such as a smart phone) of each person, in order to determine if the two people are at the meeting place at the same time (i.e. thereby confirming the meeting).

In accordance with an eleventh aspect of the invention there is provided a system for facilitating/arranging/scheduling/managing a meeting, wherein the system includes a scheduling/facilitation module which is configured to:
determine/suggest a possible meeting place for two or more people to meet and communicating the meeting place to both people via a communication network;
determine whether the two people are at the meeting place; and
receive a payment amount into an account, wherein the payment amount is received as a result of a purchase(s) made by one or both people at the meeting place.

The payment amount may be received from an account with is associated with the particular meeting place (e.g. a coffee shop).

The payment amount may relate to a royalty fee/referral fee which is received from an entity which is associated with the meeting place (e.g. the entity owning/running the meeting place, such as a coffee shop).

The scheduling/facilitation module may more specifically be configured to determine/suggest a possible meeting place based on (i) a present geographical location of each user or (ii) a possible future geographical location of each user at a particular point in time. The scheduling/facilitation module may be configured to receive, via a communication network (e.g. a mobile telecommunication network), information on (i) the present geographical location of each user or (ii) the possible future geographical location of each user at a particular point in time. For each user, the information on (i) the present geographical location of the said user or (ii) the possible future geographical location of the said user, may be received from a mobile telecommunication device, more specifically a smart device, of the said user.

The scheduling/facilitation module may be configured to use geographic location information which is associated with a mobile communication device (e.g. a smart device, such as a smart phone) of each person, in order to determine if the two people are at the meeting place at the same time (i.e. thereby confirming the meeting).

In accordance with a twelfth aspect of the invention there is provided a non-transitory computer readable storage medium on which instructions are stored which, if executed by a processor/computer, performs the method in accordance with the first, fourth, sixth, eight or tenth aspect of the invention.

### BRIEF DESCRIPTION OF THE DRAWINGS

The invention will now be described, by way of example, with reference to the accompanying diagrammatic drawings. In the drawings:

FIG. 1 shows a schematic illustration of the operation of the system in accordance with the invention;

FIG. 2 shows a schematic layout of the system in accordance with the invention;

FIG. 3 shows a flow diagram which illustrations part of the operation of the system shown in FIGS. 1 and 2;

FIG. 4 shows a screenshot of a sign in/registration screen of the mobile application which forms part of the system shown in FIGS. 1 and 2;

FIG. 5 shows a screenshot of a user interface screen of the mobile application where a user is asked to provide additional information;

FIG. 6 shows a screenshot of a user interface screen of the mobile application where a user is asked to specify his/her interests;

FIG. 7 shows a screenshot of a user interface screen of the mobile application where contacts can be added;

FIG. 8 shows a screenshot of a user interface screen of the mobile application where another user's profile information is displayed (after the other user's QR code has been scanned);

FIG. 9 shows a screenshot of a user interface screen of the mobile application where availability information can be provided;

FIG. 10 shows a screenshot of a home screen of the mobile application;

FIG. 11 shows a screenshot of a notification screen of the mobile application;

FIG. 12 shows a screenshot of a quick meeting invite screen of the mobile application;

FIG. 13 shows a screenshot of a profile information screen of a connected person;

FIG. 14 shows a screenshot of a meeting invite creation screen of the mobile application;

FIG. 15 shows a screenshot of an agenda screen of the mobile application;

FIG. 16 shows a screenshot of a meeting invite information screen of the mobile application;

FIG. 17 shows a screenshot of a received meeting invite screen of the mobile application;

FIG. 18 shows a screenshot of a check-in screen for a particular meeting;

FIG. 19 shows a screenshot of a screen showing a QR code for a coupon which can be redeemed; and

FIG. 20 shows a flow diagram of how the system in accordance with the invention can manage and track the effectiveness of an advertising campaign.

### DESCRIPTION OF PREFERRED EMBODIMENTS

The present invention provides a system/platform which allows people who are connected to one another (e.g. through one or more social networking platforms) to set up meetings based on when and where they will be available for possible meetings. The system also provides a suggested meeting place based on where the relevant people will be at the time when the proposed meeting should take place. This is done by determining the geographic location of where both people will be during a particular time, based on their respective schedule information. For example, a particular person may stay in Boston but have meetings scheduled in New York for 1-5 February and may be available for meetings in New York at certain time periods during his/her stay in New York. The system is capable of determining which people, which are connected with the particular person, may be able to meet with the person in New York, based on the respective schedules of those particular people. If it is determined that two of the person's connected people will also be in New York during that time and could be available for meetings, then the system 10 proposes possible meetings with the identified people, together with suggested meeting places.

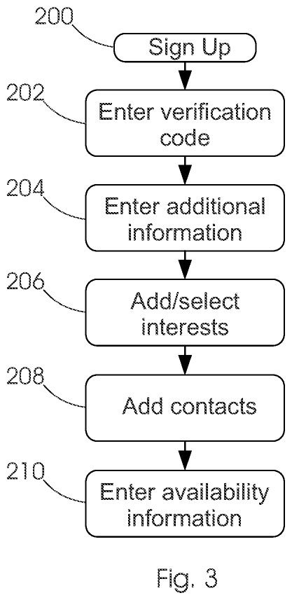

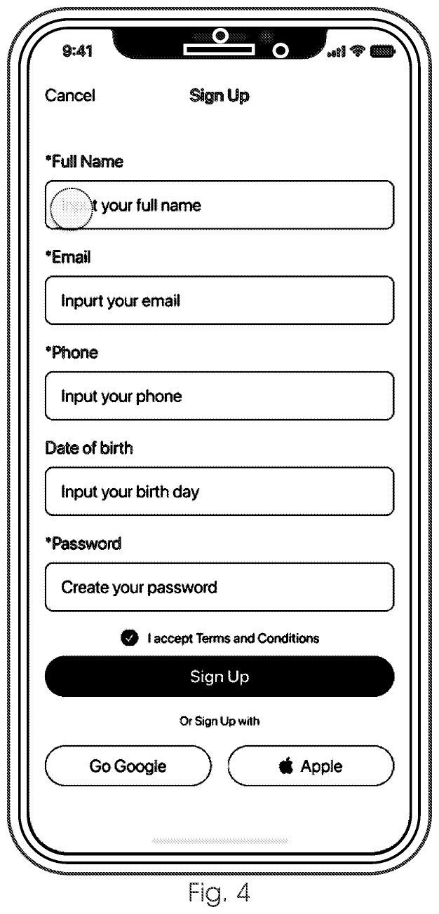

In the drawings, reference numeral 10 refers generally to a system in accordance with the invention. In one embodiment, the system 10 can be specifically used for scheduling meetings. In order to start, a user 100.1-100.4 (hereinafter collectively referred to as “users 100”) need to sign up/register with the system 10 (see FIG. 3, block 200). This may be done by firstly downloading a mobile application which is associated with the system, 10. During the sign-up process, the user 100 would typically enter his/her full name, email address, cellphone number, date of birth and a password as shown in FIG. 4 (using the mobile application). Once this information has been added, a verification code is sent to a smart phone 12.1-12.4 (hereinafter collectively referred to as “smart phones 12”) of the user 100, who then needs to enter this verification code in order to proceed (see block 202).

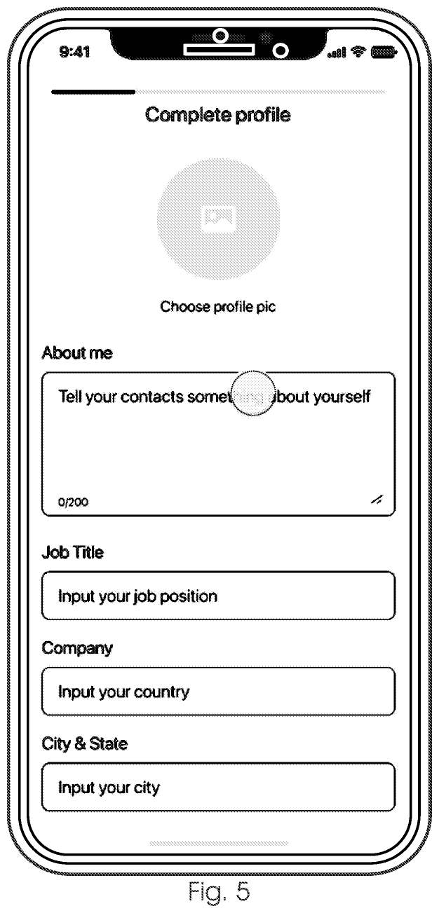

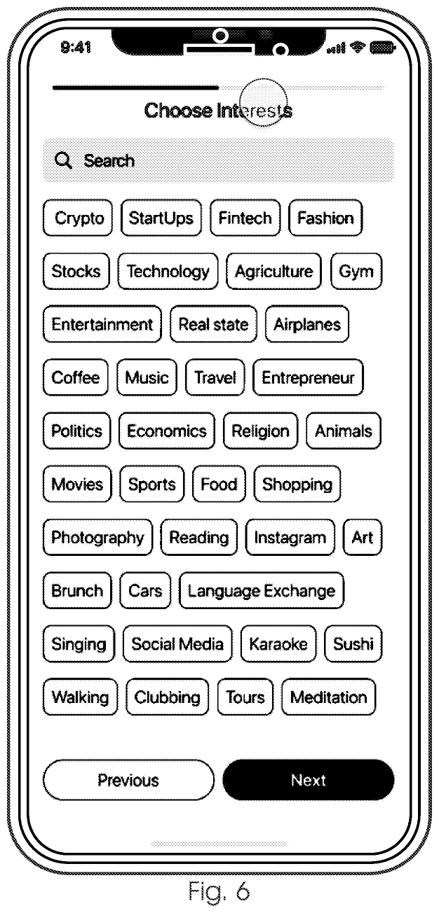

After the verification code has been confirmed, the user 100 can enter additional information (see FIG. 3, block 204) by specifying certain information about the person (i.e. by completing an “about me” block), including a job title and company which the user is currently working at, as well as a current city, state and country (see FIG. 5). The user 100 can also upload a profile picture. Furthermore, the user 100 can also specify his/her Covid vaccine status (e.g. vaccinated or unvaccinated). Next, the user 100 is asked to select any interests which the user 100 may have, such as crypto, fashion, gym, real estate, etc. (see FIG. 6, as well as FIG. 3, block 206).

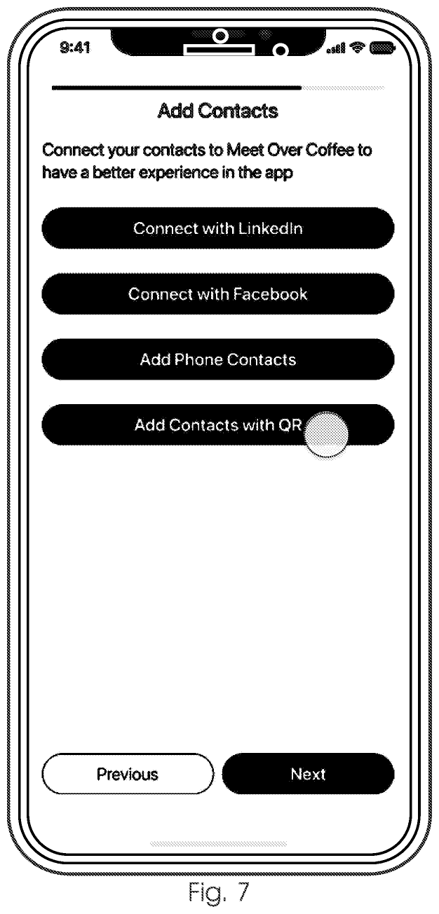

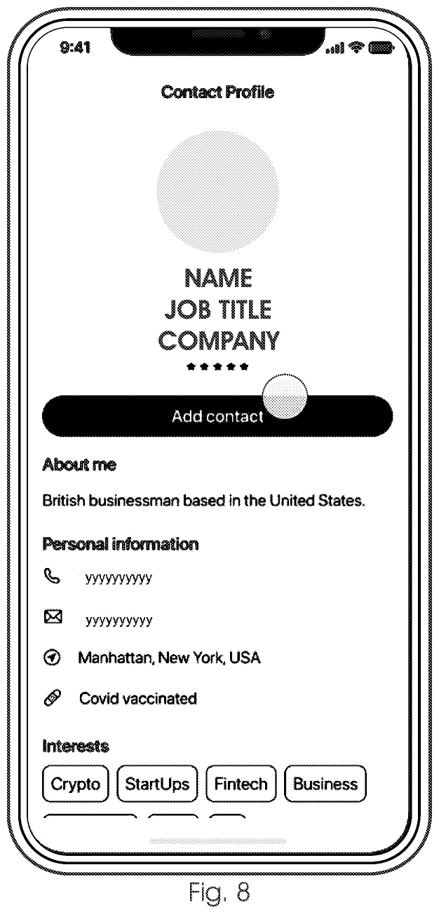

A user 100 is then asked by the system 10 to add contacts to his/her profile (also referred to as “connected people”) (see FIG. 7 and FIG. 3, block 208) by:
a) Connecting to one or more social networking platforms which is used by the user 100, such as LinkedIn and Facebook. The user's connections on these platforms (e.g. Facebook friends) can then be linked to/incorporated in his/her profile;
b) Adding phone contacts (e.g. contacts stored on the user's phone 12); and/or
c) Adding people which are already signed on/registered with the system 10, by scanning a user profile QR code which represents the particular person (e.g. the person may show the QR code on his phone, which the user 100 can then scan). Once scanned, the profile of the person is displayed as shown in FIG. 8 and the person can then be added as a contact by selecting “Add contact”.

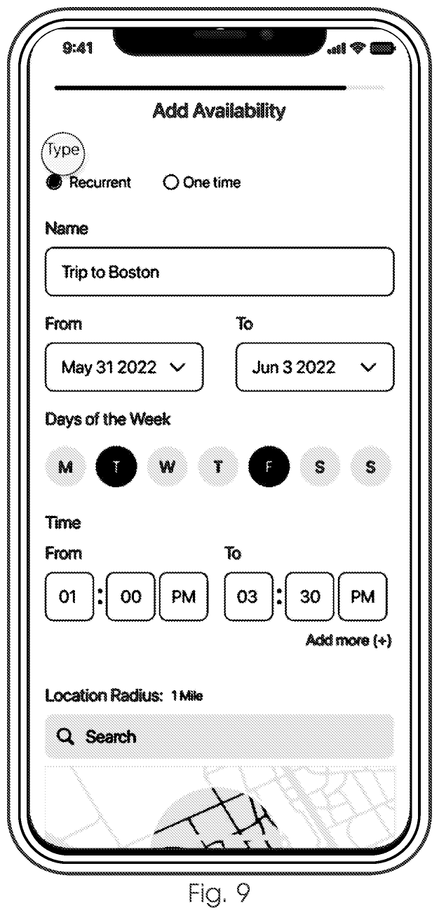

After the contacts have been added, a user is asked to provide availability information (see FIG. 9 and FIG. 3, block 210). When adding the availability information, the user can specify:
whether the particular availability will be a recurring event or only a one-time event;
the name of the availability (e.g. “Trip to Boston”);
a start date and end date of the particular availability entry (e.g. from 31 May 2022 till 3 Jun. 2022);
specific days of the week during which the person will be available (e.g. the Tuesday and Friday);
the time period(s) during which the person will be available (e.g. 1:00 PM to 3:30 PM—additional time periods can also be added); and
a location radius of where the person will be during the particular period of availability (e.g. within 1 mile of a particular hotel).

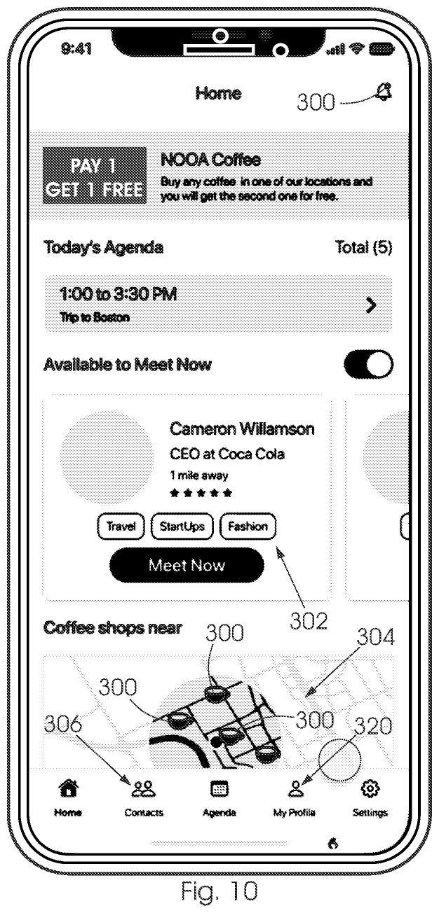

Once the availability information has been added, the user 100 is presented with a view of his/her profile and, if the user 100 is satisfied, the profile can be created for the user 100. Once created, the user 100 is presented with a home screen as shown in FIG. 10.

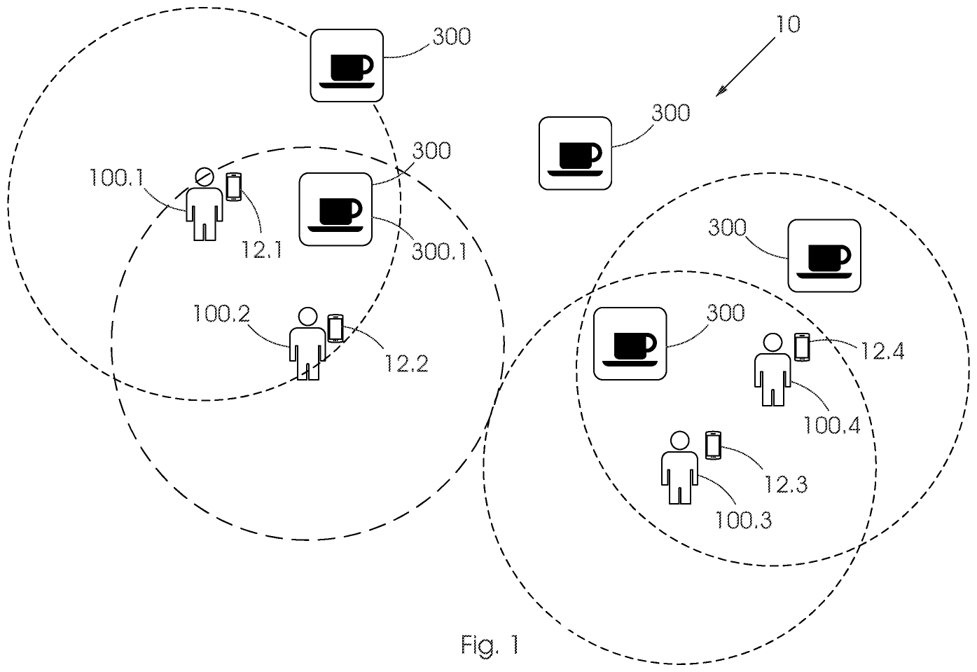

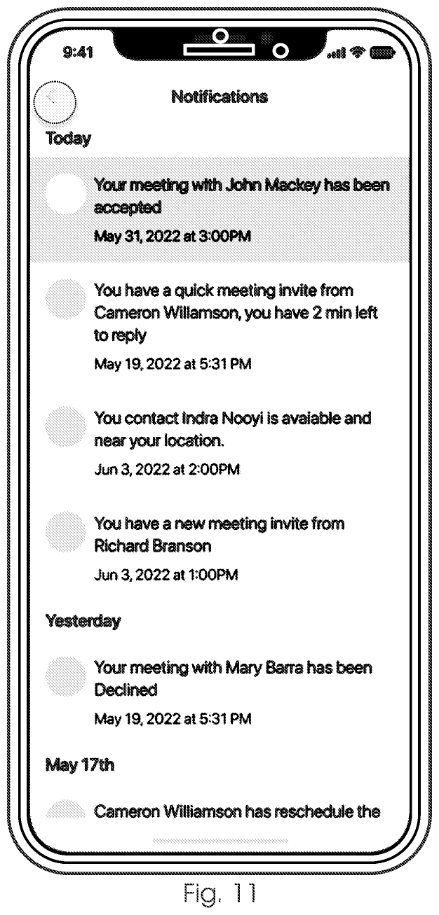

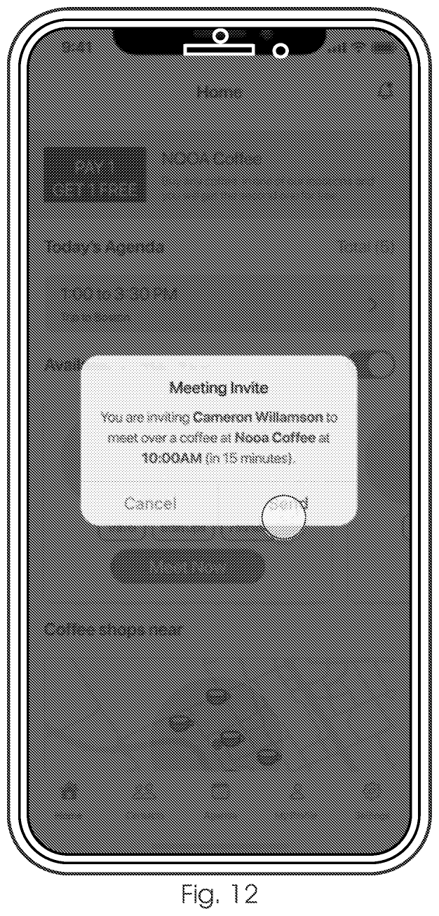

Via the home screen, the user 100 can select a number of options. For example, the user may select a notification icon 300 in order to view (i) any meeting invites which he/she may have received, (ii) notifications regarding meetings which have been accepted (i.e. based on invites sent by the user 100 to one or more connected people) and (iii) nearby connected people (e.g. based on their relative geographic locations—obtained from their respective phones 12) which may be available for a meeting (see FIG. 11). The home screen also indicates the current day's availability, as well as details of meetings already scheduled. There is also an option to activate/deactivate an “available to meet now” status, which, if activated, shows that the user 100 is currently available to meet. The screen also then shows nearby people which are available to meet now (see reference numeral 302). A meeting invite can then be sent to nearby connected people (again based on their relative geographic locations—obtained from their respective phones 12) who are available to meet (by selecting the “Meet Now” button). Nearby meeting places, such as coffee shops 300, are also displayed on a geographic map (see reference numeral 304). If a meeting invite option is selected, then an invite is generated for a time in the near future (e.g. in 15 minutes) at a suggested location (e.g. a nearby coffee shop) (see FIG. 12). It should be appreciated that the suggested location is determined based on the current locations of the user (e.g 100.1—See FIG. 1) and the other person (e.g. 100.2) which the user 100.1 wishes to meet with. If the other person 100.2 accepts the meeting request, then the meeting will be added to the user's agenda (e.g. at the coffee shop 300.1.

All the interactions/communications between the user 100 and the system 10 may, in one example, be via the mobile application installed on the user's phone/other smart device.

In one example, the system 10 may incorporate at least one artificial intelligence (AI) or machine learning module/model which can be utilised in order to suggest to a user 100 a person (who is also registered with the system 10) to meet with, which may not be one of his contacts (i.e. not within the user's network). More specifically, the machine learning module/model may be configured to perform a compatibility function between the user 100 and other people registered on the system 10 in order to identify one or more people who the user 100 may wish to meet. For example, a user 100 could enable a setting on the mobile application (e.g. under a “preferences” section/tab provided on the mobile application) which allows the system 10 to suggest people they could meet with that are outside of their own network(s). The setting up of a suggested meeting may typically be performed in the same manner as describe above and further below.

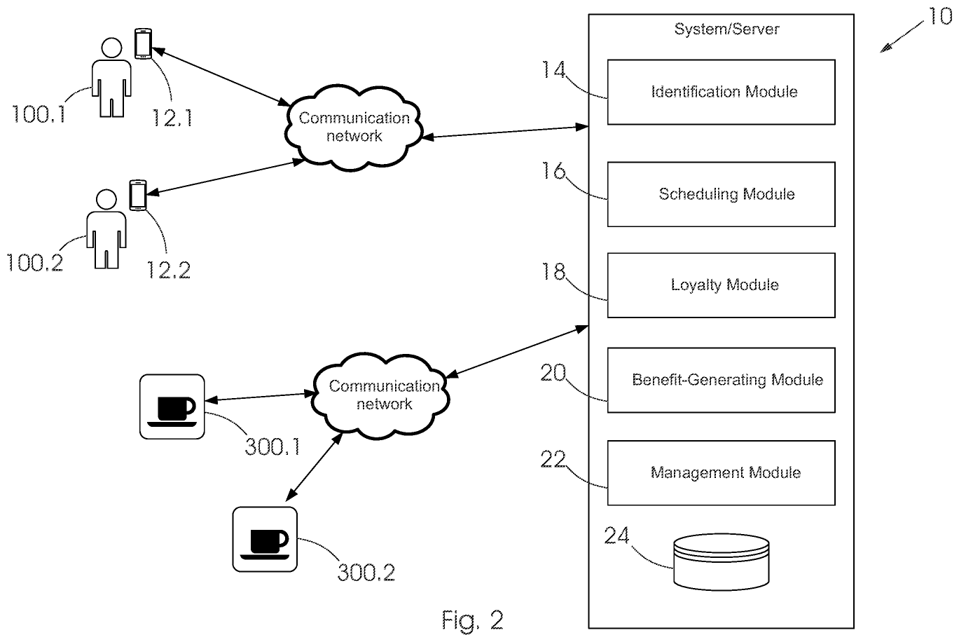

It should be noted that all the functions relating to the identification of possible people to meet as described above and below can typically be performed by an identification module 14 of the system 10 (see FIG. 2). The actual scheduling of meetings in the manner described above and below can typically be performed by a scheduling module 16 of the system 10.

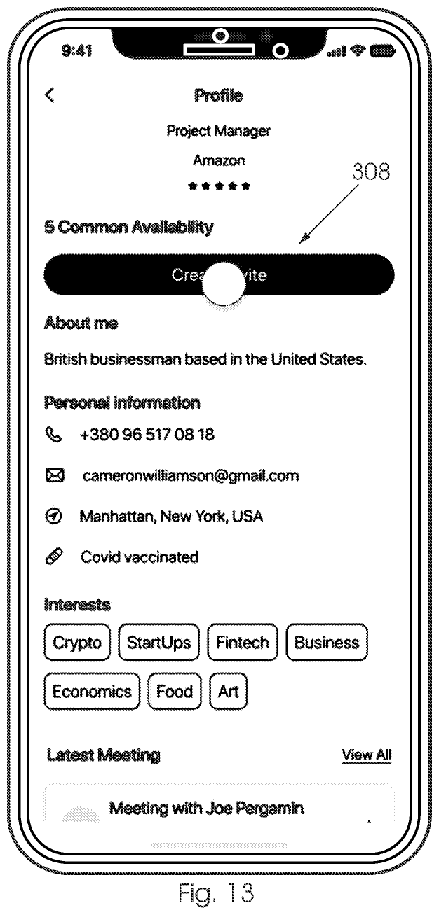

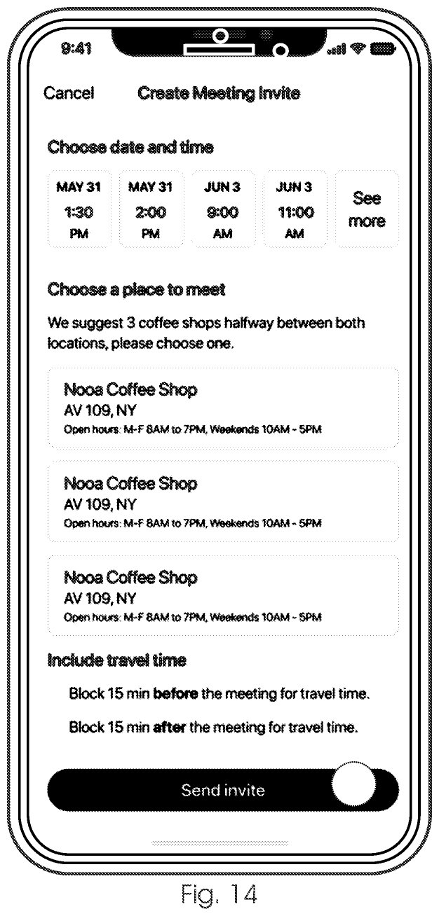

By selecting the “contacts” option 306 on the home screen, a user 100 is able to see his existing contacts (the “connected people”) and also add any contacts in a similar manner as described during the sign up/registration process. By selecting a particular contact, the user 100 is able to see the user profile of the particular person, which includes contact information and personal interests as shown in FIG. 13. A meeting invite can then also be sent to the person by selecting the “create invite” option 308 which, if selected, provides the user 100 with the screen shown in FIG. 14. User 100 can then select a possible meeting date and time (a number of proposed dates and times may be provided by the scheduling module 16 based on the availability of both users) and possible meeting place. In this regard, the system 10 (more specifically the scheduling module 16) may provide a number of options to the user based on the locations of both user's (i.e. where the users may be during the selected timeslot).

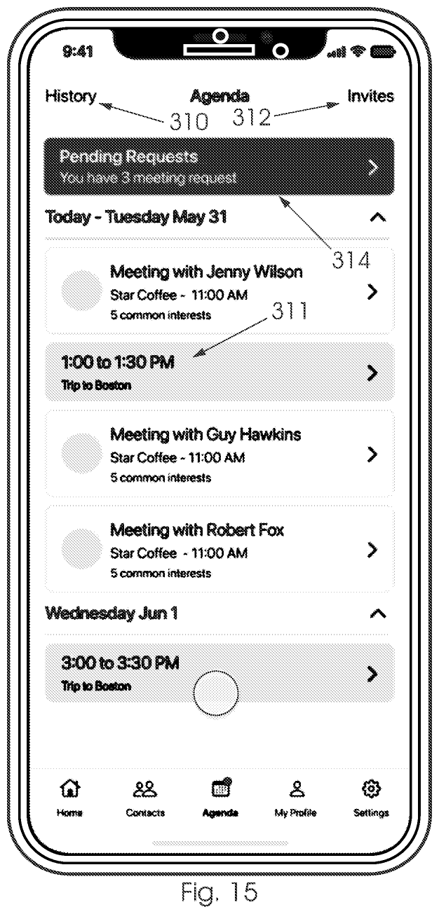

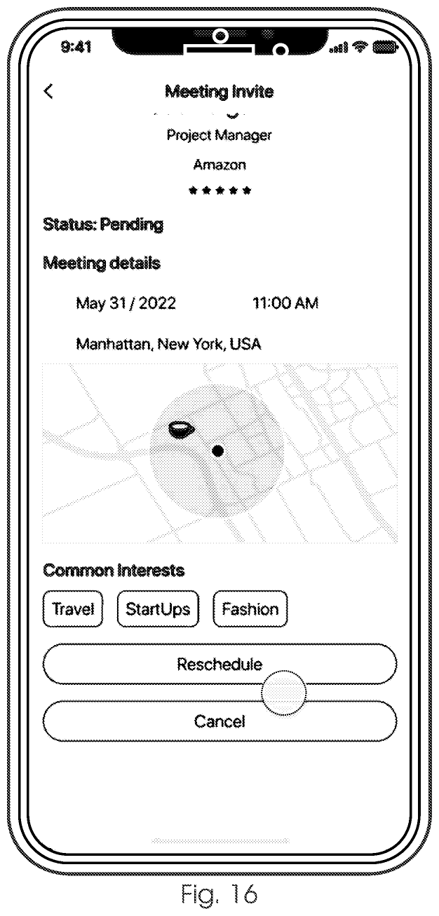

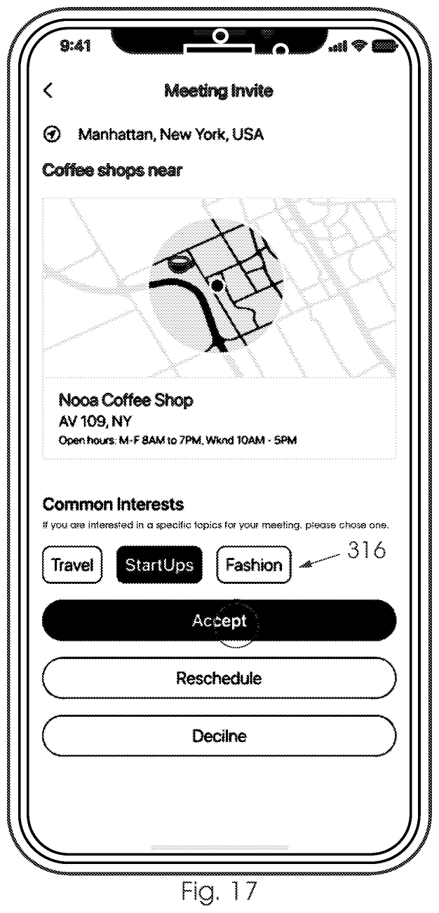

By selecting the “agenda” option on the home screen (see FIG. 15), the user 100 is able to see their scheduled meetings for the next few days, as well as periods of availability (see reference numeral 311). By selecting the “history” option 310, details of historical meetings can be viewed. If the “invites” option 312 is selected, then details of received and sent invites can be viewed. If a particular invite is then selected, the status of the invite is shown (e.g. pending or confirmed) (see FIG. 16). The user 100 is also provided with the option to reschedule, if needed. When responding to an invite, the user 100 is able to accept the meeting and also, at the same time, select a common interest which the user would like to talk about during the meeting (see FIG. 17). The common interests are typically presented on the user interface as indicated by reference numeral 316. When a meeting has been confirmed, then it is possible for a user 100 to select a “chat” option in order to chat to the other person (e.g. regarding the finer details of the meeting).

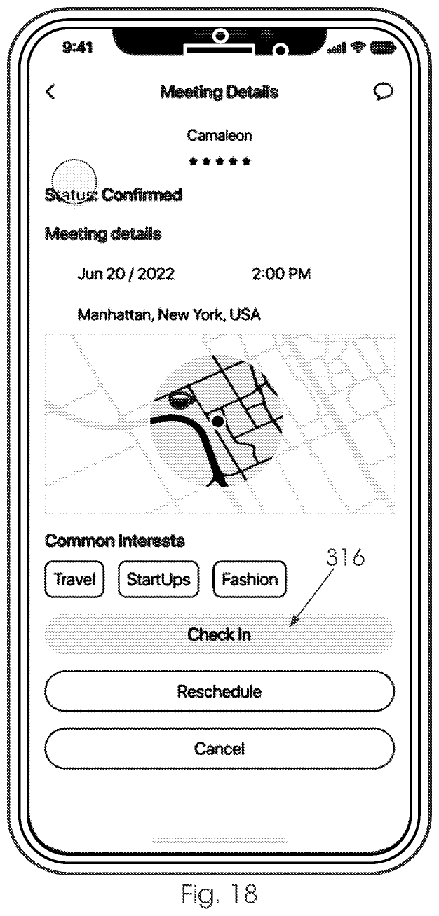

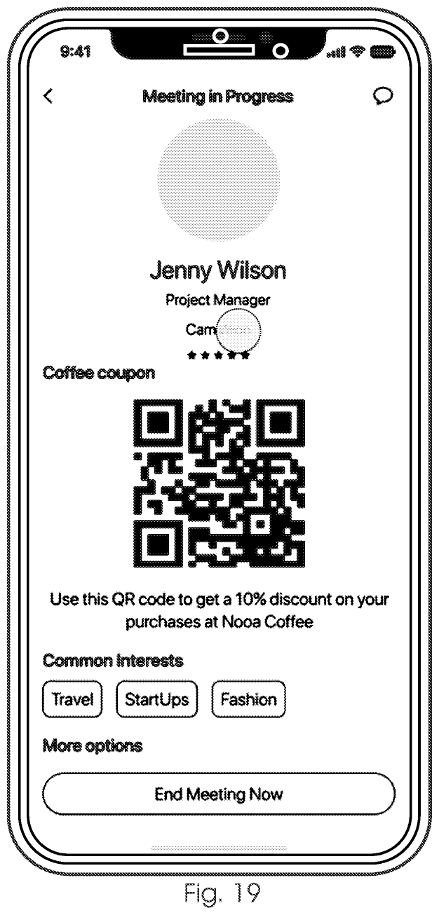

At the time when the meeting is scheduled to take place, a user 100 can select a “check in” option (see reference numeral 318 in FIG. 18). If both people are checked in, a coupon (e.g. for a 10% discount) is generated by a benefit-generating module 20 of the system 10 and presented as a QR code to both users (see FIG. 19) which can then be redeemed at the particular meeting place (e.g. the coffee shop). At the end of the meeting, each user can review the other person (or report them, if there is was an issue. In this regard, it should be noted that the system 10 is configured to utilise the geographic location of a user's phone to determine whether the user is actually at the meeting place and will only allow him/her to check in, once it has been established that the user is in fact at the meeting place.

By selecting the “profile” option 320 on the home screen, a user can view and edit his/her profile information. Information on availability can also be updated/edited in the same manner as during the sign-up process (see FIG. 9).

The system in accordance with the invention may also be configured to manage a loyalty program. In this example, a plurality of different independent stores/business/companies (e.g. different coffee brand stores) may form part of the loyalty program and therefore also the system 10. For example, the entity hosting the system 10 may have negotiated certain terms and conditions whereby when a particular user 100 has purchased a certain number of beverages (e.g. coffees) or other items/products (e.g. 10) at the network of independent stores/business/companies which form part of the system 10, the next beverage (or other item/product) is paid by the entity hosting the system (e.g. at a wholesale price—pre-negotiated with the particular store/business/company)), instead of the user 100 himself/herself (i.e. thereby effectively providing the user 100 with an incentive benefit or type of coupon which can be redeemed). In other words, the user 100 will then effectively get the next beverage for free. It should also be noted that the purchases need not necessarily by all made at a specific store, but can be across a range of independent stores which form part of the network (e.g. the shops/stores 300.1-300.4). For example, if a user purchases five coffees at store A, 4 coffees at store B and 1 coffee at store C (where stores A-C all form part of the network), then he/she will be able to get his/her next coffee for free when ordering it at any of the network of stores (e.g. at store C or another store D).

The monitoring function of the loyalty program described above can typically be managed/performed by a loyalty module 18 of the system 10, while the generation of the incentive benefit/coupon (e.g. for the free coffee) can be generated by a benefit-generating module 20.

Details of the network of stores/business/companies are typically stored on a database 24.

The system in accordance with the invention may also be configured to generate a coupon/discount/incentive benefit which can be redeemed by users 100 when the system 10 (more specifically the scheduling module 16) has successfully managed to suggest a possible meeting place (which forms part of the system's network of stores/business/companies) for two users to meet (in the manner as described above) and both users meet up at the suggested meeting place (e.g. a nearby coffee shop 300). More specifically, the scheduling module 16 is configured to use geographic location information which is associated with a mobile communication device (more specifically a smart device 12, such as a smart phone) of each user 100, in order to determine if the two users are at the suggested meeting place at the same time (i.e. thereby confirming the meeting). If so, then the system 10 (more specifically a benefit-generating module 20) generates coupon/discount/incentive benefit which can be redeemed by both users 100 at the suggested meeting place. For example, both users 100 may receive a coupon on their mobile app (e.g. in the form of a QR code) for a 10% discount on a purchase made at the meeting place.

The system 10 in accordance with the invention may also be configured to obtaining an indication of an effectiveness of an advertising campaign. In this regard, the system 10 may include a management module 22 which is configured to:
identify a group of people to advertise an event to, based on pre-selected criteria (e.g. age, interests, etc.); and
obtain an indication as to how many people from the group attended the event by using geographic location information of smart devices which are each associated with a particular person from the group, wherein the geographic location information relates to the location of the smart devices 12 of users at the time/time period when/during which the event occurred/occurs.

In other words, the system 10 can determine how many people attended a particular event versus the number of people the event was advertised to. For example, the event was advertised to 250,000 people and 10,000 people attended the event.

More specifically, the system 10 (more specifically the management module 22) can be used to send advertising campaigns/advertisements to a group of users 100 and then determine the effectiveness of the advertising campaigns/advertisements. The advertising campaign/advertisement would typically relate to a specific event which will take place at a future date and time at a specific place. The system 10 is accordingly configured to allow a company wanting to launch the advertising campaign to communicate the advertisements to some of the system's users 100. The specific selection of users 100 may, for example, be based on a specific demographic of users (e.g. people between the ages of 20 and 40 years old) who may be in the same general geographic area as the specific place during the specified date and time (based on their personal schedules). The selection may also be based on which users 100 may be available for the event, based on their schedules. Once the group of users 100 have been identified, an advertisement can be sent to the identified users 100, who will each receive a notification on their mobile application. Each user 100 is then able to either decline the event or accept it, in which case the system 10 will add it to his/her schedule (similar to other meeting invites described above). If a user 100 ends up attending the event, he/she can “check in” at the event, in a similar manner as described earlier in the specification (i.e. the check-in is based on the geographic location of the user 100—i.e. he/she can only check in if at the location of the event. Once checked in, the system 10 identifies that the advertising campaign has been successful in convincing the particular user to attend the event and stores details thereof on the database 24.

For example, a coffee place may wish to advertise an event where exotic coffee will be served at a reduced price at the coffee place, and where an artist will also be performing live music. The details of the event may therefore include:
the Date and Time (e.g. 5 Oct. 2022 From 18:00-21:00);
Place/location (e.g. the location of the specific coffee place, which may for example be based in New York);
Interests which the person should have (e.g. coffee and live music); and
Additional details, such as the name of the artist that will be performing.

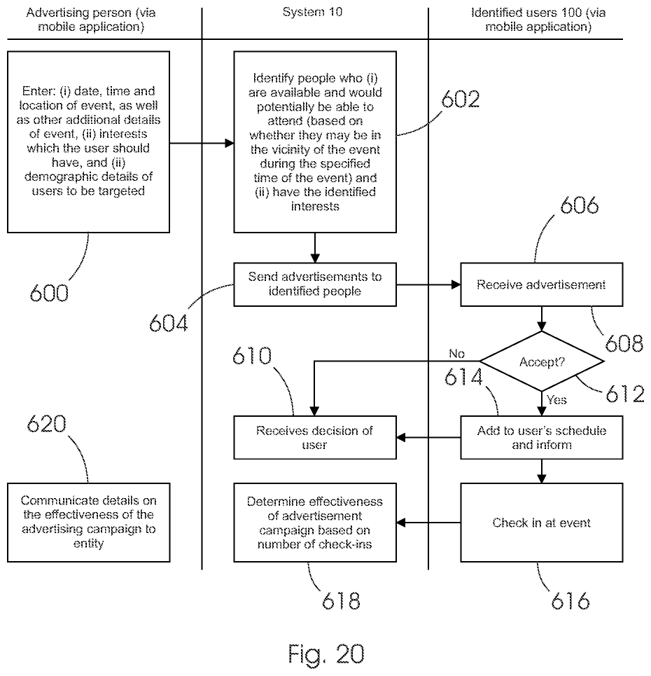

These details may be entered onto the system 10 by a specific person (the “advertising person”) of the coffee place who is involved in the planning of the event (or specifically on the advertising side of the event). The person can also add details of the specific demographic of people to who the advertisement should be sent out (e.g. people between the ages of 20-40 and which have a particular interest in both live music and coffee) (see FIG. 20, block 600).

The system 10 can then use these details to identify users which:
1. will be available to attend the event, based on where they will be during the time period at which the event will take place and whether they will be available to attend (based on their schedules); and
2. have interest in both live music and coffee. In this regard, the system 10 would use the “interests” entered by users 100 during the sign-up process, in order to identify the particular users (see block 602).

The advertising person can also select a budget for the campaign or specify the number of users the advertisement should be sent to (e.g. 10,000 people).

The system then sends the advertisements to the identified users 100. Each user 100 will receive a notification/advertisement within their mobile application which provides the details of the event (i.e. it is effectively an invite to the event) (see block 604). The user 100 can then either decline or accept the event invitation. If accepted, the system 10 adds the event to the user's schedule (see blocks 610, 612 and 614).

The user 100 will then be able to check in at the event in a similar manner as described above (see block 616). In this regard, it should again be noted that the system 10 is configured to utilise the geographic location of a user's phone to determine whether the user 100 is actually at the event and will only allow him/her to check in, once it has been established that the user 100 is in fact at the location of the event. The system 10 is then able to determine the effectiveness of the advertising campaign based on the total number of check-ins of users 100 versus the total number of users to who the advertisement has been sent (e.g. 200 check-ins versus 10,000 invites sent) (see block 618). Details of the effectiveness can then be communicated to the entity which held the event (e.g. via the mobile app installed on an advertising person's phone) (see block 620).

The system 10 in accordance with the invention may also be configured to receive a certain amount of money from a particular meeting place (which forms part of the system's network, e.g. a coffee shop), when the system 10 has managed to successfully set up a meeting at the coffee shop (as described above) and one or both users 100 end up making purchases at the coffee shop. For example, the coffee shop may pay an amount (e.g. a fixed fee or a percentage of the total purchase amount received from a user 100 (e.g. 1%)) into a bank account of the entity hosting/operating the system 10 for successfully setting up a meeting at the coffee shop.

The inventor believes that the invention in accordance with the invention provides an effective and intelligent way of setting up meetings and managing advertising campaigns.

1. A method of facilitating a meeting, wherein the method includes:
determining/suggesting, by using a processor, a possible meeting place for two or more people to meet and communicating the meeting place to both people via a communication network; and
determining, by using a processor, whether the two people are at the meeting place, and if so, generating a coupon/discount/incentive benefit which can be redeemed by one or both people at the meeting place.

2. The method of claim 1, wherein the determining/suggesting step more specifically includes determining/suggesting a possible meeting place based on (i) a present geographical location of each user or (ii) a possible future geographical location of each user at a particular point in time.

3. The method of claim 2, which includes receiving, via a communication network, information on (i) the present geographical location of each user or (ii) the possible future geographical location of each user at a particular point in time.

4. The method of claim 3, wherein for each user, the information on (i) the present geographical location of the said user or (ii) the possible future geographical location of the said user, is received from a mobile telecommunication device of the said user.

5. The method of claim 4, wherein the step of determining whether the two people are at the meeting place includes using geographic location information which is associated with a mobile communication device of each person, in order to determine if the two people are at the meeting place at the same time.

6. The method of claim 5, which includes communicating details of the coupon/discount/incentive benefit via a communication network to the mobile communication device of one, or each of, the users.

7. A system for facilitating a meeting, wherein the system includes a scheduling module which is configured to:
determine/suggest a possible meeting place for two or more people to meet and communicate the meeting place to both people via a communication network; and
determine whether the two people are at the meeting place, and if so, generate a coupon/discount/incentive benefit which can be redeemed by one or both people at the meeting place.

8. The system of claim 7, wherein the scheduling module is more specifically configured to determine/suggest a possible meeting place based on (i) a present geographical location of each user or (ii) a possible future geographical location of each user at a particular point in time.

9. The system of claim 8, wherein the scheduling module is configured to, via a communication network, receive information on (i) the present geographical location of each user or (ii) the possible future geographical location of each user at a particular point in time.

10. The system of claim 8, wherein for each user, the information on (i) the present geographical location of the said user or (ii) the possible future geographical location of the said user, is received from a mobile telecommunication device of the said user.

11. The system of claim 10, wherein the scheduling module is configured to use geographic location information which is associated with a mobile communication device of each person, in order to determine if the two people are at the meeting place at the same time.

12. The system of claim 11, which is configured to communicate details of the coupon/discount/incentive benefit via a communication network to the mobile communication device of one, or each of, the users.

13-55. (canceled)

56. A non-transitory computer readable storage medium on which instructions are stored which, if executed by a processor/computer, performs the method as claimed in claim 1.

57-60. (canceled)
